(19) United States
(12) Patent Application Publication
(10) Pub. No.: US 2021/0018465 A1
(43) Pub. Date: Jan. 21, 2021

(54) Devices and Methods for Processing Fluid Samples

(71) Applicant: DH Technologies Development PTE Ltd., Singapore (SG)

(72) Inventors: David D. Y. Chen, Vancouver (CA); Chang Liu, Richmond Hill (CA)

(21) Appl. No.: 17/030,285

(22) Filed: Sep. 23, 2020

Related U.S. Application Data
(62) Division of application No. 15/329,268, filed on Jan. 26, 2017.

(51) Int. Cl. G01N 27/447; G01N 30/00; G01N 1/40

(52) U.S. Cl. CPC G01N 27/44765; G01N 27/44791; G01N 30/0005; B01L 3/502715; G01N 1/40; G01N 27/44743; G01N 2001/4038; G01N 27/44769

(57) ABSTRACT

Provided is the processing of sample fluids containing one or more analytes of interest and to methods and devices for separating and/or purifying components of a sample fluid using electric and hydrodynamic forces. Though the fluid processing systems and methods are generally described herein as applied to microfluidics, it will be appreciated that the fluid processing systems may process any fluid volume suitable for use in embodiments described herein. Y-shaped and multiple-branched shaped 2-D EFD devices have been used to separate and/or purify one or more analytes from a mixture. Systems and methods in accordance with various aspects of the present teachings utilize hydrodynamic pressure (e.g., using a pump) to drive the sample liquid from the sample inlet to the separation stream, and can, in some aspects, provide improved control of the movement of the analytes, improved processing times, and decreased buffer depletion.

### RELATED APPLICATIONS

This application is a divisional of U.S. application Ser. No. 15/329,268, filed on Jan. 26, 2017, which is related to and claims priority to PCT Application No. PCT/IB2015/055740, filed on Jul. 29, 2015, which is related to and claims priority to U.S. provisional application No. 62/030,989, filed on Jul. 30, 2014, all of which are incorporated herein by reference in their entirety.

### FIELD

The present teachings generally relate to the processing of sample fluids containing one or more analytes of interest, and more particularly, to methods and devices for separating and/or purifying components of a sample fluid using electric and hydrodynamic forces.

### INTRODUCTION

Purifying biological materials such as proteins, DNAs, lipids, and metabolites in physiological conditions is essential in understanding life processes. The purification technologies currently available, such as two-dimensional gel electrophoresis, analytical chromatography and capillary electrophoresis, usually require denaturation of biomolecules or are incapable of processing a reasonable amount of material. While capillary electrophoresis (CE), which utilizes the differential mobility of charged species in an applied electric field, can be used to separate species that cannot be reliably resolved by other methods, fraction collection of CE generally produces small amounts of purified sample components due to limitations associated with the physical dimensions of the capillary columns. More recently, two-dimensional electro-fluid-dynamic (2-D EFD) devices have utilized hydrodynamic pressure, as well as an electric field, to drive analyte and fluid migration through two-dimensional channel networks (as opposed to the one-dimensional columns of CE). 2-D EFD devices have been shown to continuously purify multiple components from complex samples into different channels, each containing a substantially pure compound, as described for example in “Reverse of Mixing Process with a Two-Dimensional Electro-Fluid-Dynamic Device,” Anal. Chem., 82:2182-2185 (2010), and “Potential of Two-Dimensional Electro-Fluid-Dynami Devices for Continuous Purification of Multiple Components from Complex Sample,” Anal. Chem., 83:8208-8214 (2011), which list as authors the present inventors et al. and are incorporated by reference in their entireties. In these exemplary 2-D EFD devices, analytes are driven through the fluid by non-discriminative forces (e.g., pressure or electroosmosis) and by discriminative forces (e.g., from the applied electric field). These forces exist simultaneously and produce a net migration of analytes determined by the sum of the velocity vectors. For example, in conventional 2D-EFD devices, a positive electric potential is applied at a sample vial to drive charged analytes within the sample into and against a flow of an electrolytic fluid in a separation stream, of which the pressure-induced velocity can be precisely controlled so as to manipulate the migration of the various analytes in the same direction as or against the bulk flow of fluid in the separation channel due to the electrophoretic mobility of the particular analyte.

There remains a need for improved devices for performing continuous chemical purification and/or separation.

### SUMMARY

In some aspects, the present teachings provide methods and systems for simultaneously obtaining multiple fractions having simpler compositions, including pure biological compounds solutions from a complex mixture, and can enable the complete processing of a whole sample, without the need for pre-fractionation. As described above, known 2-D EFD utilize a fluid flow in a main separation channel into which one or more analyte can be injected utilizing an electric potential applied at a sample vial to drive charged analytes within the sample into a micro scale channel for separation. In accordance with various aspects of the present teachings, systems and methods in accordance with the present teachings utilize a pressure-driven bulk fluid flow to deliver a sample fluid into the separation stream without discriminating individual analytes based on their charge status, and can provide faster sample processing, resistance to unstable electroosmotic flow, and avoid buffer depletion that is common in known 2D-EFD device. Further, the continuous nature allows the complete processing of the mixture that is constantly introduced. The techniques disclosed herein can also be combined with other separation, reaction, and detection techniques to further characterize the purified fractions or compounds to determine their molecular composition, structure and biological and chemical activities. In various embodiments, a sample channel can comprise a channel network. In various embodiments, a separation channel can comprise a channel network. In various embodiments, a collection channel can comprise a channel network.

In accordance with one aspect, certain embodiments of the applicant's teaching relate to a microfluidic device for separating components of a fluid sample comprising one of a sample channel and channel network extending between an inlet end and an outlet junction, the inlet end configured to receive a fluid sample containing one or more analytes to be delivered to the outlet junction, wherein a fluid pressure of the fluid sample at the inlet end of one of the sample channel and channel network is greater than a fluid pressure at the outlet junction. The device also includes one of a separation channel and channel network in fluid communication with the one of the sample channel and channel network, one of the separation channel and channel network extending from an inlet end to said outlet junction, the inlet end of one of the separation channel and channel network configured to receive a counter-flow fluid, wherein a fluid pressure of the counter-flow fluid at the inlet end of one of the separation channel and channel network is greater than said fluid pressure at the outlet junction. A first collection channel or at least one of a collection channel and channel network is in fluid communication with one of the separation channel and channel network and one of the sample channel and channel network at the outlet junction and a plurality of electrodes generate an electric field within one of the separation channel and channel network and the first collection channel or at least one of the collection channel and channel network. In some aspects, the device can include a sample pump (e.g., a syringe pump) fluidically coupled to the inlet end of one of the sample channel and channel network for pumping the fluid sample from the inlet end of one of the sample channel and channel network to the outlet junction. In various aspects, the electric field and a hydrodynamic force on the one or more analytes at the outlet junction preferentially drive the one or more analytes into one of said separation channel or channel network and said first collection channel or said at least one of the collection channel or channel network.

In various aspects, the microfluidic device can further comprise a counter-flow pump (e.g., a syringe pump) fluidically coupled to the inlet end of one of the separation channel and channel network for pumping the counter-flow fluid from the inlet end of one of the separation channel and channel network to the outlet junction.

In various aspects, one of the sample channel and channel network can comprise a substantially electric field-free region. For example, the inlet end of one of the sample channel and channel network can be electrically floated. In some aspects, the plurality of electrodes are arranged so as to generate a substantially electric field-free region in one of the sample channel and channel network. For example, in related aspects, none of the plurality of electrodes are disposed adjacent the inlet end of one of the sample channel and channel network.

According to various aspects of the present teachings, at least one of the fluid pressure at the inlet end of one of the sample channel and channel network, the fluid pressure at the inlet end of one of the separation channel and channel network, and the electric field generated by the plurality of electrodes can be adjustable such that a first species of analyte is preferentially driven into said first collection channel or one of said at least one collection channel and channel network and a second species of analyte is preferentially driven into one of said separation channel and channel network. In some aspects, the fluid flow velocity through the sample channel, the separation channel, and/or the collection channel can be controlled utilizing one or more pumps.

In some aspects, one of the first collection channel and channel network extends from the outlet junction to a first fluid reservoir, with one of the plurality of electrodes being in contact with fluid in the first fluid reservoir. For example, one of the first collection channel and channel network can extend from the outlet junction to a first fluid reservoir and the device can further comprise one of a second collection channel and channel network extending from one of the separation channel and channel network at a second fluid separation junction spaced a distance apart from the outlet junction, one of the second collection channel and channel network defining a fluid flow pathway between the second fluid separation junction and a second fluid reservoir. In related aspects, one of the plurality of electrodes can be in contact with fluid in the first fluid reservoir and one of the plurality of electrodes can be in contact with fluid in the second fluid reservoir. In some aspects, one of a third collection channel and channel network extending from one of the separation channel and channel network at a third fluid separation junction spaced a distance apart from the outlet junction and the second fluid separation junction can also be provided, one of the third collection channel and channel network defining a fluid flow pathway between the third fluid separation junction and a third fluid reservoir. By way of example, the second fluid separation junction can be disposed between the outlet junction and the third fluid separation junction. In some aspects, a first electrode of the plurality of electrodes can be in contact with fluid in the first fluid reservoir, a second electrode of the plurality of electrodes can be in contact with fluid in the second fluid reservoir, and a third electrode of the plurality of electrodes can be in contact with fluid in the third fluid reservoir. In such aspects, at least one of the fluid pressure at the inlet end of one of the sample channel and channel network, the fluid pressure at the inlet end of one of the separation channel and channel network, and the electric field generated by the plurality of electrodes can be adjustable such that a first species of analyte is preferentially driven into one of said first collection channel and channel network and a second and third species of analyte is preferentially driven into one of said separation channel and channel network. Additionally in some aspects, at least one of the fluid pressure at the inlet end of one of the sample channel and channel network, the fluid pressure at the inlet end of one of the separation channel and channel network, and the electric field generated by the plurality of electrodes can be adjustable such that the second species of analyte is preferentially driven into one of the second collection channel and channel network and the third species of analyte is preferentially driven into one of the third collection channel and channel network.

The electrodes can have a variety of configurations and potentials applied thereto. For example, the first and second electrodes of the at least three electrodes can be equipotential, and wherein at least one of an average cross-sectional area and a channel length of one of the collection channels and channel network differ from one another. In related aspects, a single power source can be electrically coupled to the first and second electrodes for applying an electric potential thereto. Alternatively, an electric potential applied to the first and second electrodes can differ from one another, and wherein at least one of an average cross-sectional area and a channel length of one of the collection channels and channel network are substantially equal. For example, a first and a second power source can be electrically coupled to the first and second electrodes, respectively, for applying an electric potential thereto.

In accordance with one aspect, certain embodiments of the applicant's teaching relate to a microfluidic device for separating components of a fluid sample comprising a pump fluidically coupled to one of the sample channel and channel network for pumping a fluid sample containing one or more analytes from an inlet end of one of the sample channel and channel network to an outlet junction via a substantially electric field-free pathway; one of a separation channel and channel network in fluid communication with one of the sample channel and channel network, one of the separation channel and channel network extending from an inlet end to said outlet junction, the inlet end of one of the separation channel and channel network configured to receive a counter-flow fluid; a first collection channel or at least one of a collection channel and channel network in fluid communication with one of the separation channel and channel network and one of the sample channel and channel network at the outlet junction; and a plurality of electrodes configured to generate an electric field within one of the separation channel and channel network and the first collection channel or at least one of the collection channel and channel network, wherein the electric field and a hydrodynamic force on the one or more analytes at the outlet junction preferentially drive the one or more analytes into one of said separation channel or channel network and said first collection channel or at least one of the collection channel or channel network. In some aspects, at least one of a volumetric flow rate of the fluid sample, a volumetric flow rate of the counter-flow fluid, and the electric field generated by the plurality of electrodes can be adjustable such that a first species of analyte is preferentially driven into said first collection channel or one of said at least one collection channel and channel network and a second species of analyte can be preferentially driven into one of said separation channel and channel network.

In accordance with one aspect, certain embodiments of the applicant's teaching relate to a method of separating fluids comprising: pumping a sample fluid from an inlet end of one of a sample channel and channel network to an outlet junction; pumping a counter-flow fluid from an inlet end of one of a separation channel and channel network to the outlet junction; and generating an electric field in the one of the separation channel and channel network such that one or more analytes in the sample fluid at the outlet junction are preferentially driven into one of said separation channel and channel network and a first collection channel or at least one of a collection channel and channel network in fluid communication with one of the separation channel and channel network and one of the sample channel and channel network at the outlet junction.

In some aspects, the method can also include adjusting at least one of a volumetric flow rate of the fluid sample, a volumetric flow rate of the counter-flow fluid, and the electric field such that a first species of analyte is preferentially driven into said first collection channel or one of a respective collection channel and channel network and a second species of analyte is preferentially driven into one of said separation channel and channel network.

In various aspects, one of the sample channel and channel network can be a substantially electric field-free pathway. In some aspects, the sample fluid can be pumped at a substantially constant volumetric flow rate while adjusting a volumetric flow rate of the counter-flow fluid so as to effect an interaction between a hydrodynamic force and electric field experienced by the one or more analytes at the outlet junction, e.g., so as manipulate along which channel is preferentially driven.

In some aspects, the first collection channel or at least one of the collection channel and channel network can extend from the outlet junction to a first or respective fluid reservoir, a second collection channel or channel network can extend from the separation channel or channel network at a second fluid separation junction spaced a distance apart from the outlet junction (the second collection channel or channel network defining a fluid flow pathway between the second fluid separation junction and a second fluid reservoir), and a third collection channel or channel network can extend from the separation channel or channel network at a third fluid separation junction spaced a distance apart from the outlet junction (the third collection channel or channel network defining a fluid flow pathway between the third fluid separation junction and a second fluid reservoir), wherein a first electrode is in contact with fluid in the first fluid reservoir, a second electrode is in contact with fluid in the second fluid reservoir, and a third electrode is in contact with fluid in the third fluid reservoir. In a related aspect, the method can comprise adjusting at least one of a volumetric flow rate of the fluid sample, a volumetric flow rate of the counter-flow fluid, and an electric potential applied to one of the first, second, and third electrodes such that a first species of analyte is preferentially driven into said first or respective collection channel or channel network and a second and third species of analyte is preferentially driven into said separation channel or channel network.

In related aspects, the method can also include adjusting at least one of the volumetric flow rate of the fluid sample, the volumetric flow rate of the counter-flow fluid, and the electric potential applied to one of the first, second, and third electrodes such that the second species of analyte is preferentially driven into one of a respective collection channel or channel network, i.e., second collection channel or channel network and the third species of analyte is preferentially driven into said respective or third collection channel or channel network.

In some aspects, at least one of an average cross-sectional area and a channel length of the first and second collection channels or one of the collection channel and channel network can differ from one another, and the method can further comprise maintaining the potential applied to the first and second electrodes substantially equal. For example, a single power source can be used to generate an electric potential at the first and second electrodes.

Alternatively, at least one of an average cross-sectional area and a channel length of the first and second collection channels or one of the collection channels and channel network can be substantially equal to one another, the method further comprising applying an electric potential of different magnitudes to the first and second electrodes. For example, a first and a second power source can be electrically coupled to the first and second electrodes, respectively, for applying an electric potential thereto.

In accordance with one aspect, certain embodiments of the applicant's teaching relate to a microfluidic device for separating components of a fluid sample, comprising: one of a sample channel and channel network extending from an inlet end fluidically coupled to a reservoir of a fluid sample to a first intersection junction, the fluid sample containing one or more analytes; one of a separation channel and channel network in fluid communication with one of the sample channel and channel network, one of the separation channel and channel network extending from an inlet end to said first intersection junction, the inlet end of one of the separation channel and channel network configured to receive a counter-flow fluid; a first collection channel or at least one of a collection channel and channel network in fluid communication with one of the separation channel and channel network at the first intersection junction, one of the first or respective collection channel and channel network extending from the first intersection junction to a first or respective collection reservoir in contact with a first or respective electrode to which a first or respective electric potential can be applied; and a second collection channel or channel network in fluid communication with the separation channel or channel network at a second intersection junction spaces apart from the first intersection junction, the second collection channel or channel network extending from the second intersection junction to a second or respective collection reservoir in contact with a second electrode to which a second electric potential can be applied. The electrodes are configured to generate an electric field within one of the separation channel and channel network and the first and second collection channels or at least one of the respective collection channel and channel network. At least one of an average cross-sectional area and channel length of the first and second collection channels or one of the collection channels or channel network differ from one another. In some aspects, the first and second electrodes are equipotential, and the potential can be applied by a single power source. In some aspects, the device can include a sample electrode for electrokinetically driving the analytes within the sample fluid from the sample inlet to the first intersection point.

These and other features of the applicant's teachings are set forth herein and in the appendix attached hereto, which is hereby incorporated by reference in its entirety.

### BRIEF DESCRIPTION OF THE DRAWINGS

The skilled person in the art will understand that the drawings, described below, are for illustration purposes only. The drawings are not intended to limit the scope of the applicant's teachings in any way.

FIG. 1, in schematic diagram, illustrates an exemplary microfluidic device for separating components of a fluid sample in accordance with one aspect of various embodiments of the applicant's teachings.

FIG. 2, schematically illustrates the exemplary microfluidic device of FIG. 1.

FIG. 3, in schematic diagram, illustrates another exemplary microfluidic device for separating components of a fluid sample in accordance with one aspect of various embodiments of the applicant's teachings.

FIG. 4 illustrates the use of the exemplary microfluidic device of FIG. 1 in manipulating the flow of an analyte therethrough.

FIG. 5 illustrates the use of the exemplary microfluidic device of FIG. 3 in manipulating the flow of an analyte therethrough.

FIG. 6 illustrates the use of the exemplary microfluidic device of FIG. 1 to separate and/or purify a plurality of analytes.

FIG. 7 illustrates the use of the exemplary microfluidic device of FIG. 3 to separate and/or purify a plurality of analytes.

FIG. 8, in schematic diagram, illustrates another exemplary microfluidic device for separating components of a fluid sample in accordance with one aspect of various embodiments of the applicant's teachings.

### DETAILED DESCRIPTION

It will be appreciated that for clarity, the following discussion will explicate various aspects of embodiments of the applicant's teachings, while omitting certain specific details wherever convenient or appropriate to do so. For example, discussion of like or analogous features in alternative embodiments may be somewhat abbreviated. Well-known ideas or concepts may also for brevity not be discussed in any great detail. The skilled person will recognize that some embodiments of the applicant's teachings may not require certain of the specifically described details in every implementation, which are set forth herein only to provide a thorough understanding of the embodiments. Similarly it will be apparent that the described embodiments may be susceptible to alteration or variation according to common general knowledge without departing from the scope of the disclosure. The following detailed description of embodiments is not to be regarded as limiting the scope of the applicant's teachings in any manner. On the contrary, the applicant's teachings encompass various alternatives, modifications, and equivalents, as will be appreciated by those of skill in the art. The features illustrated or described in connection with one exemplary embodiment may be combined with the features of other embodiments. Such modifications and variations are intended to be included within the scope of the applicants' disclosure. Various terms are used herein consistent with their customary meanings in the art. The term “about” as used herein indicates a variation of less than 10%, or less than 5%, or less than 2%.

The present teachings generally relate to the processing of sample fluids containing one or more analytes of interest, and more particularly, to methods and devices for separating and/or purifying components of a sample fluid using electric and hydrodynamic forces. Though the fluid processing systems and methods are generally described herein as applied to microfluidics, it will be appreciated in light of the present teachings that the fluid processing systems may process any fluid volume suitable for use in embodiments described herein. As discussed above, Y-shaped and multiple-branched shaped 2-D EFD devices have been used to separate and/or purify one or more analytes from a mixture. In known devices, an electric field in the sample channel or channel network is utilized to overcome the effect of back pressure to deliver the analytes to be purified into the separation stream (generally referred to herein as electrokinetic injection). However, as discussed in detail below, systems and methods in accordance with various aspects of the present teachings instead utilize hydrodynamic pressure (e.g., using a pump) to drive the sample liquid from the sample inlet to the separation stream, and can, in some aspects, provide improved control of the movement of the analytes, improved processing times, and decreased buffer depletion.

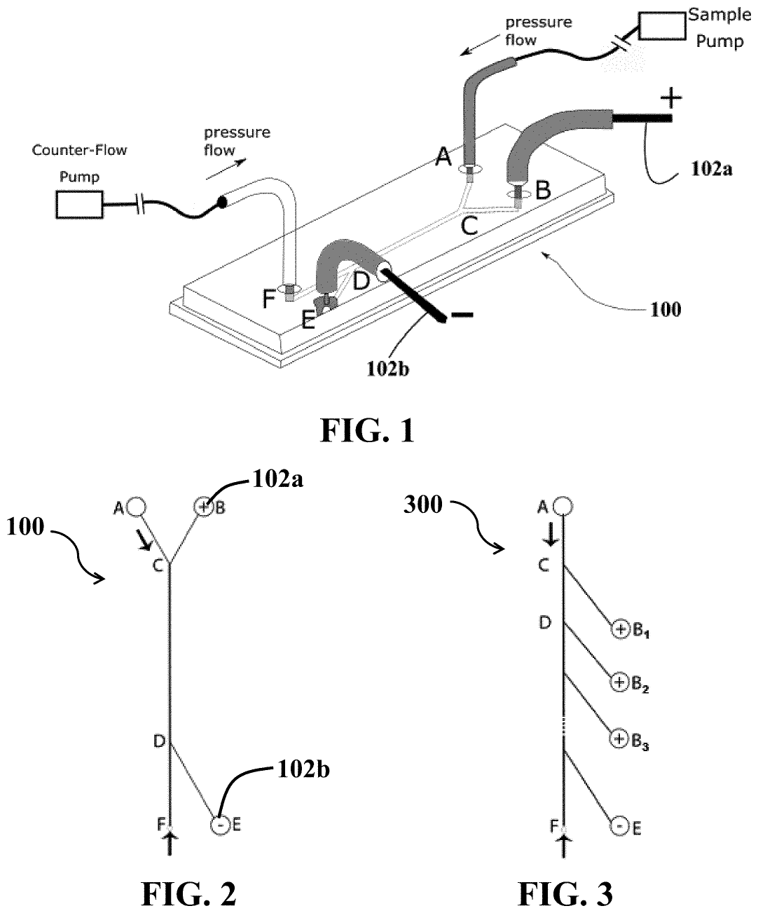

With reference now to FIGS. 1 and 2, an exemplary microfluidic device 100 for separating components of a fluid sample 100 in accordance with various aspects of applicant's teachings is illustrated schematically. As will be appreciated by a person skilled in the art, the microfluidic device 100 represents only one possible configuration in accordance with various aspects of the systems, devices, and methods described herein. In various embodiments, a sample channel can comprise a channel network. In various embodiments, a separation channel can comprise a channel network. In various embodiments, a collection channel can comprise a channel network. As shown in FIG. 1, the exemplary microfluidic device 100 generally comprises a sample channel (segment AC) that intersects a separation channel (segment CD) and a collection channel (segment BC) at intersection point (C). The sample channel (AC) extends from an inlet end (A) to its outlet end or outlet junction (C), from which the separation channel (CD) generally extends towards the counter-flowinlet end (F) and the collection channel (BC) extends towards a terminal end or fluid reservoir (B) for collecting a fluid transmitted through the microfluidic channel network. As shown in FIG. 1, the device 100 can also include a plurality of electrodes for generating an electric field in the separation channel (CD) and the collection channel (BC) as discussed in detail below.

The inlet end (A) of the sample channel (AC) can have a variety of configurations but is generally configured to receive thereat a fluid sample containing one or more analytes to be separated and/or purified by the microfluidic device 100, as indicated by the upper arrow in FIGS. 1 and 2. For example, the inlet end (A) can be configured to fluidically couple to a source or reservoir of a fluid sample through any number of conduits, fittings, and valve. By way of example, the inlet end (A) of the sample channel (AC) can be coupled directly or indirectly to a sample fluid supply (not shown). It will also be appreciated in light of the present teachings that the sample fluid can be delivered to and/or through the sample channel (AC) utilizing one or more pumping mechanisms (e.g., micro-pumps, syringe pumps, electroosmotic pumps) for generating a stable flow of sample fluid within the sample channel (AC). By way of non-limiting example, a syringe pump (e.g., from Harvard Apparatus, Holliston, Mass.), which are known to be highly tunable and can provide a precise, accurate, smooth, pulse-less flow, can be used to precisely deliver the sample fluid to the outlet junction (C) through the sample channel (AC). The pumping mechanism can generate a pressure-driven flow in the sample channel (AC), for example, by maintaining the pressure at the inlet end (A) at a higher pressure than the outlet end (C) of the sample channel (AC) such that analytes contained within the fluid are generally transmitted to the outlet end (C) at the average fluid velocity of the sample fluid.

The inlet end (F) of the separation channel (CD) can also have a variety of configurations but is generally configured to receive thereat a fluid delivered under pressure to the intersection point (C), as indicated by the lower arrow in FIGS. 1 and 2. For example, the inlet end (F) can be configured to fluidically couple directly or indirectly to a source or reservoir of a buffer or another counter-flow fluid through any number of conduits, fittings, and valve. Like the sample fluid in the sample channel (AC), the counter-flow fluid within the separation channel (CD) can be pumped (e.g., using any of a micro-pump, a syringe pump, an electroosmotic pump) to the intersection point (C). It will be appreciated that the counter-flow fluid can be any fluid suitable for use in accordance with the present teachings, for example, an electrically-conductive fluid containing electrolytes. One exemplary counter-flow fluid contains a background electrolyte (e.g., 160 mM borate, pH 9) in which the concentration of the buffer is substantially higher relative to the analyte of interest in the sample fluid.

As shown in FIG. 1, the device can include a plurality of electrodes to which electric potentials can be applied from one or more power sources (not shown) so as to generate an electric field within the fluid in the separation channel (CD) and collection channel (BC). In the exemplary embodiment, the device 100 includes a first electrode 102a in contact with the fluid at the terminal end or reservoir (B) of the collection channel (BC) and a second electrode 102b in contact with the fluid at a lateral channel or second collection channel (DE) that extends from the separation channel (CD) at a second intersection point (D). It will be appreciated in light of the present teachings, the electric field is generated such within the collection channel (BC) and separation channel (CD) such that the field generally drives a charged analyte of interest away from the terminal end or reservoir (B) and against the bulk fluid flow. As discussed otherwise herein, analytes would thus be driven against the fluid flow by discriminative forces (e.g., from the applied electric field) based on the electrophoretic mobility of the particular analyte. Simultaneously, a non-discriminative force (e.g., pressure) produces a net migration of all analytes with the fluid such that the net migration is determined by the sum of the velocity vectors of the forces. By way of non-limiting example, in a sample fluid containing analyte(s) of interest exhibiting a positive charge, the electrode 102a would generally be configured to exhibit a positive potential relative to electrode 102b such that the analytes at the intersection point (C) are repulsed away from electrode 102a and/or attracted toward electrode 102b. It will be appreciated that the potential applied to the electrodes 102a,b can have a variety of configurations so as to generate such an electric field. For example, both electrodes 102a and 102b can be maintained at a positive potential relative to ground, though the electrode 102a can have a larger magnitude. Alternatively, electrode 102a can exhibit a positive potential while electrode 102b can be grounded or maintained at a negative potential.

In some aspects, the plurality of the electrodes of the microfluidic device 100 can be configured such that the sample channel (AC) is generally a field-free region (e.g., analytes are driven to the intersection point (C) through non-discriminative forces such as a positive pressure differential between the sample inlet (A) and the outlet junction (C) and are not subject to a substantial electric forces). For example, as shown in FIGS. 1 and 2, the electric field generated by electrodes 102a,b do not generate a substantial electric field within the sample channel (AC). It will also be appreciated in light of the present teachings, for example, that additional electrodes can be utilized to adjust the electric field strength to be zero within the sample channel (AC) and/or reduce electrolysis of the sample buffer through contact with an electrode. By way of example, an electrode at the sample inlet (A) can be maintained at substantially the same potential as an electrode in contact with the fluid at the intersection point (C) such that there is substantially no electric potential difference (e.g., ΔV less than 10V, ΔV less than 1% potential applied to electrode 102a) between the auxiliary electrodes. In some aspects, a current between an electrode at the sample inlet (A) and an electrode in contact with the fluid at the intersection point (C) can be monitored such that potential applied to one or more of the electrodes can be adjusted to substantially eliminate the current. Alternatively, in one embodiment, the electrode 102a can be maintained at a positive potential (e.g., 1000 V), the electrode 102b can be maintained at a negative potential (e.g., −900 V), and an electrode at the intersection point (C) can serve as ground or be floated. Likewise, an electrode at the sample inlet can be grounded or be floated such that analytes in the sample channel (AC) do not experience an electric field. As noted above, the potentials applied to the electrodes 102a,b (1000V and −900V, respectively) can be applied by one or more high-voltage power supply (e.g., SL150, Spellman High Voltage Electronics, Hauppage, N.Y.). Moreover, as discussed in detail below, the value of the electric fields exhibited in different channels can be altered by changing the voltages applied to the electrodes so as to manipulate the channel into which a particular analytes species is preferentially drive.

It will be appreciated that devices in accordance with the present teachings can be manufactured using any of a plastic, polymer such as PDMS (e.g., Sylard184, Dow Corning, Midland, Mich.), glass, or any other suitable material(s) into which the channels described herein can be formed. By way of non-limiting example, the substrate can comprise soda lime glass (Nanofilm, Westlake Village, Calif.) within which channels are formed using known photolithographic patterning and wet chemical etching methods.

With reference now to FIG. 3, another exemplary device 300 for processing a sample fluid is depicted in which the sample channel (AC) is substantially field-free. Rather, the sample (and analyted contained therein) is introduced into the initial intersection point (C) under the influence of pressure-driven flow. The microfluidic device 300 is similar to that depicted in FIGS. 1 and 2, but differs in that in includes additional collection channels extending from the separation channel at spaced apart intersection points. This multi-branched device 300, for example, includes three collection channels terminating at B₁, B₂, and B₃ to allow for the separation and/or collection of a plurality of fractions. In various embodiments, a sample channel can comprise a channel network. In various embodiments, a separation channel can comprise a channel network. In various embodiments, a collection channel can comprise a channel network.

Like the exemplary device of FIG. 1, a plurality of electrodes are also included for generating an electric field in the separation channel (CD) as well as the multiple collection channels that extend therefrom. As discussed otherwise herein, the electric field generated in the separation channel (CD) and each of the collection channels (e.g., CB₁ and CB₂) can be selected such that a first analyte is preferentially driven into the channel CB₁, while a second and third analyte remain in the separation channel at intersection point (C). Continuing against the fluid flow generated by a counter-flow pump, the second analyte can be preferentially collected in the collection channel CB₂, for example, while the analyte remains in the separation channel at intersection point (D). It will be appreciated in light of the present teachings, that each of the electrodes at B₁, B₂, and B₃ can have a distinct electric potential applied (e.g., relative to electrode (E) via one or more power sources) so as to preferentially drive a particular analyte into each of these symmetric collection channels.

It should be appreciated, however, in light of the present teachings that the channels for processing the fluids can have a variety of dimensions and/or cross-sectional shapes. Though the calculations presented below regarding exemplary fluid and electric fields present in the various channels of the exemplary devices are presented with regard to symmetric channels (having identical cross sections) or of a fixed ratio of cross-sections, theoretical calculations can likewise be determined in light of the present teachings for channels of any cross-sectional area. For example, though the theoretical calculations and experimental results demonstrate the use of an exemplary symmetrical Y-shaped device 100 in which the channels (AC) and (BC) are symmetrical about the separation channel (CD) and a multiple-branched device 300 in which the width of the main separation channel (CD) is 80 μm and the width of the sample channel (AC) and collection channel(s) (BC) is 40 μm (each has a depth of 50 μm), it should be appreciated that these values (both absolute and relative to one another) are merely exemplary and do not necessarily limit the present teachings. For example, the width of the sample channel (AC) and collection channel (BC) could be 50 μm, the width of the main channel (CD 100 μm, and the depth of all PDMS channels could be 200 μm.

Likewise, with reference again to FIG. 3, rather than using a separate power supply and/or distinct independent potentials applied to the electrodes at the end of the collecting channels which exhibit a consistent cross-sectional area, a single high-voltage power supply can be used to maintain the electrodes at the terminal end of each collection channel at the same electric potential, while the width of each channel is manipulated to achieve the proper balance of the bulk flow velocity field and the electric field for continuous chemical purification and/or separation, which could improve the cost and robustness of operation.

With reference now to FIG. 8, another exemplary device 800 for processing a sample fluid is depicted. Like the device 300 of FIG. 3, the device 800 includes multiple collection channels extending from the separation channel at spaced apart intersection points (S₁, S₂, and S₃). This multi-branched device 800, for example, includes three collection channels terminating at electrodes S_{1′}, S_{2′}, and S_{3′} to which a single high-voltage power supply can be utilized to provide the same electric potential to each electrode at the terminal end of each of the collection channels. As discussed above, the width of each of the collection channel can be manipulated to achieve the proper balance of bulk flow velocity and electric field. Unlike in devices 100 and 300 discussed above, however, analytes from the fluid sample are driven from the sample inlet (A) to the intersection point (S₁) against the fluid-flow from the inlet end (P) of the separation channel due to their electrophoretic mobility as in conventional 2D-EFD devices, rather than by maintaining a pressure-driven fluid flow in the sample channel. In various embodiments, a sample channel can comprise a channel network. In various embodiments, a separation channel can comprise a channel network. In various embodiments, a collection channel can comprise a channel network.

### The Electric Field and Hydrodynamic Fluid Field Distribution in 2-D EFD Devices

In the discussions below, the directions of vectors are all along the channel length. Thus, these vectors are expressed as scalars, and the values are defined as positive when the vector direction is toward the intersection point C. The cross-sectional area of channel AC and BC are the same for the exemplary device 100, and the cross-sectional area of channel AC and CD are the same for the exemplary device 300. The cross-sectional area ratio of lateral channels and the main channel is defined as a for both the exemplary Y-shaped EFD device 100 of FIG. 1 (S_{AC}=S_{BC}=αS_{CD}) and for the multiple-branched EFD device 300 of FIG. 3 (S_{AC}=αS_{BC}=αS_{CD}).

The conductivity of the solution in the exemplary devices 100, 300 of FIGS. 1 and 3 can be considered uniform if a relatively high concentration of buffer is used.

σ_{AC}=σ_{BC}=σ_{CD} (1)

where σ is the conductivity of the solution inside each channel. From Kirchhoff's law, the net current at the intersection is zero.

J_{AC}S_{AC}+J_{AC}S_{BC}+J_{AC}S_{CD}=0 (2)

in which J is the current density in each channel and S represents the cross-sectional area of the respective channel. If Ohm's law J=σE is used in eq. (2), it becomes

E_{AC}S_{AC}+E_{AC}S_{BC}+E_{AC}S_{CD}=0 (3)

For the exemplary 2-D EFD devices 100, 300 of FIGS. 1 and 3, Eq. (3) can be reformatted according to the relationship of the channel cross-sectional area, which is αE_{AC}+αE_{BC}+E_{CD}=0 and E_{AC}+αE_{BC}+E_{CD}=0 for the exemplary Y-shaped device 100 and the exemplary multiple-branched device 300, respectively. As discussed otherwise herein, in systems and methods in accordance with various aspects of the present teachings, no external electric potential is applied at the sample inlet (A) and instead hydrodynamic pressure is utilized to deliver the sample components to the. As, the sample inlet (A) generally has the same electric potential as the outlet junction (C) such that the electric field strength in the sample channel (AC) is zero. Accordingly, in systems in accordance with various aspects of the present teachings, the electric field distribution within the channels of the exemplary devices 100, 300 can be described as follows:

$$\{ \begin{matrix}α {E}_{B C} + {E}_{C D} = 0 \\ {E}_{A C} = 0\end{matrix} \qquad ( 4 )$$

Assuming the fluid in the exemplary EFD devices 100, 300 is incompressible, the fluid velocities in the intersecting channels has the following relationship:

v_{f,AC}S_{AC}+v_{f,BC}S_{BC}+v_{f,CD}S_{CD}=0 (5)

Reformatting Eq. (5) according to the cross-sectional area relationships of the channels results in αv_{f,AC}+αv_{f,BC}+v_{f,CD}=0 for the exemplary symmetrical Y-shaped device 100 of FIG. 1 and v_{f,AC}+αv_{f,BC}+v_{f,CD}=0 for the multiple-branched device of FIG. 3.

In accordance with the present teachings, the sample fluid (and the one or more analytes therein) is hydrodynamically driven (e.g., pumped via a syringe pump) through the sample channel (AC) to the outlet junction (C) at a fixed net fluid velocity (vᵢₙⱼ). Therefore, the hydrodynamic fluid field distribution relationships can be written as and αvᵢₙⱼ+αv_{f,BC}+v_{f,CD}=0 and vᵢₙⱼ+αv_{f,BC}+v_{f,CD}=0 for the exemplary EFD devices 100, 300, respectively.

### Migration Behavior of an Analyte in 2-D EFD Devices

The steady state velocity of a charged particle that is moving in a channel can be written as

v=νₑₚ+vₑₒ+vₚ=μₑₚE+μₑₒE+vₚ=μₑₚE+v_{f} (6)

where electrophoretic velocity (vₑₚ) is discriminative and determined by its electrophoretic mobility (μₑₚ), an intrinsic property for a particular analyte. Electroosmotic velocity (vₑₒ) and pressure-induced velocity (vₚ), on the other hand, are non-discriminative and affect all components equally. As illustrated in FIG. 2, for example, the electric field and hydrodynamic pressure are opposed to one another in each of the collection channel (BC) and the separation channel (CD). It will therefore be appreciated that the steady-state migration direction reverses at the critical boundary condition (CBC) where the magnitudes of the opposed forces on an analyte are equal.

Whereas an analyte undergoing electrokinetic injection into a separation stream could have four possible mass transfer pathways according to the various combinations of electric field and pressure, in systems and methods according to the present teachings, the applied pressure delivers the analyte mixture into the device at the velocity vᵢₙⱼ such that each analyte can have only three possible mass transfer pathways. For example, in prior electrokinetic injection techniques, the steady-state velocity of the analyte in either the injection channel (AC), the collection channel (BC) and the separation channel (CD) would be in the same direction as the counter-flow when the pressure is high. As such, the analyte would be forced toward the sample inlet A and would not migrate into the sample channel AC or any other channels. Since the positive potential at point A is typically higher than that at point B, as the magnitude of applied pressure is reduced, the steady-state velocity of the analyte could be reversed first in the sample channel (AC), thereby making the analyte migrate through the outlet junction (C) and into the collection channel (BC) (i.e., to the collection vial B). As the pressure is further reduced, analytes at the intersection point (C) can migrate into both the collection channel (BC) and the separation channel (CD). Finally, in the fourth condition, when the counter-pressure in the electrokinetic injection mode is very low, all analytes would migrate along the direction of the electric field, from the sample inlet (A), through the intersection point (C) and enter the separation channel (CD).

In accordance with various aspects of the present teachings, the applied pressure delivers the analyte mixture into the device (e.g., to the outlet junction (C)) at the velocity vᵢₙⱼ such that when the counter-pressure is high, the analytes are pushed into the collection channel (BC). As the magnitude of the pressure reduces, the analytes can migrate into either collection channel (BC) or separation channel (CD). When the counter-pressure is very low, all the analyte migrate along the direction of electric field and the analyte at point C follows the migration pathway of A-C-D. The magnitude of fluid velocity in the collection channel (BC) at critical boundary conditions between these three possible mass transfer pathways can be determined to be E_{BC}μₑₚ+vᵢₙⱼ and E_{BC}μₑₚ for the exemplary symmetrical Y-shaped device 100, and

$${E}_{B C} {μ}_{e p} + \frac{1}{α} {v}_{i n j}$$

and E_{BC}μₑₚ for the exemplary multiple-branched device 300, depicted in FIGS. 1 and 3 respectively.

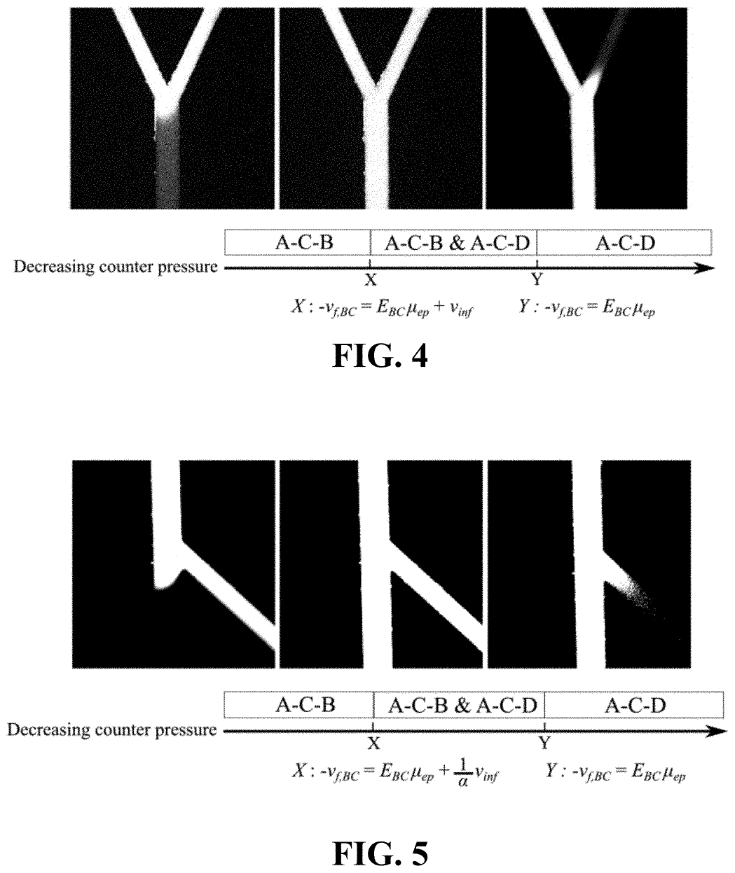

With reference now to FIGS. 4 and 5, the migration behavior of analytes in the exemplary EFD Y-shaped device 100 and multiple-branched device 300 in accordance with various aspects of the present teachings is shown at the sample channel outlet junction under various conditions of back pressure. As shown in FIGS. 3(a) and 4(a), a fluorescent dye is delivered to the outlet junction of the sample channel and then pushed into the respective collection channel (BC) when the counter pressure is very high. As shown in FIGS. 3(b) and 4(b), some of the fluorescent dye can enter the separation channel (CD) as the counter pressure is reduced to the critical boundary condition (X). As shown in FIGS. 4(c) and 5(c), substantially all of the fluorescent dye enters the separation channel (CD) as opposed to the collection channel (BC) as the counter pressure is reduced to the critical boundary condition (Y).

Whereas in current 2D-EFD electrokinetic injection devices, critical boundary conditions between the four possible mass transfer pathways are dependent on the relative electric field strengths of the particular channel(s) into which the analytes migrate, the above-discussed critical boundary conditions in an exemplary system in accordance with the present teachings demonstrate that differences between −v_{f,BC} values at the critical boundary conditions are independent of the electric field strength, and instead are only determined by the sample injection speed. It will be appreciated that this characteristic of methods and systems in accordance with the present teachings provides a more convenient approach to control the migration behavior of the analyte in the EFD device, as discussed in more detail below.

### The Effects of Changing Controlling Parameters on Critical Boundary Conditions

The critical boundary value (CBV) is defined as the value of −v_{f,BC} at the critical boundary condition (CBC). As discussed above, the fluid velocity in the collection channel (BC) at the CBCs is crucial to manipulating migration behavior of the analyte in the fluid processing systems and methods of the present teachings. For example, by changing selected parameters of the devices 100, 300 (e.g., manipulating a sample or counter pressure syringe pump to control fluid velocity or manipulating applied electric potential to effect the electric field in the collection channel (BC)), it should be appreciated that the CBVs can be easily manipulated into the appropriate value so as to force the components to follow a desired migration pathway. Because it would be impossible to change the electric field strength in only one channel by simply adjusting only one electric potential (as shown in Eq. 3) when utilizing electrokinetic injection without also changing other boundary conditions, CBVs in known devices exhibit complex relationships that may make it difficult to control analyte migration behavior.

In methods and systems in accordance with the present teachings, however, the sample fluid containing the one or more analytes to be separated can be introduced into the EFD device by hydrodynamic pressure (e.g., by pumping the sample fluid through the sample channel), such that the electric field in the collection channel (BC) and separation channel (CD) is only dependent on the difference between the electric potentials applied at points B and E. From the critical boundary conditions illustrated in FIGS. 4 and 5, a change of the sample injection speed does not affect the second CBV (Y: −v_{f,BC}=E_{BC}μₑₚ), at which the steady-state velocity of the analyte reverses at the collection channel (BC). In contrast, the first CBV (X: −v_{f,BC}=E_{BC}μₑₚ+vᵢₙⱼ for exemplary device 100 or

$$- {v}_{f , BC} = {E}_{B C} {μ}_{e p} + \frac{1}{α} {v}_{i n j}$$

for exemplary device 300), where the analyte changes the migration direction in channel CD, can be manipulated with a magnitude of Δvᵢₙⱼ for the symmetrical Y-shaped EFD device 100 and

$$\frac{1}{α} Δ {v}_{i n j}$$

for the multiple-branched EFD device 300. It should thus be appreciated in light of the present teachings that changing the sample injection speed can provide a convenient approach to adjusting the difference between two the CBVs, while the second CBV (Y) nonetheless remains unchanged.

Likewise, it should also be appreciated in light of the present teachings that adjustments to the electric field in the collection channel (BC) and the separation channel (CD) (e.g., by changing the relative potential of point (B) to point (E)) can also be utilized to control CBV values in systems and methods described herein. Because the difference between the two CBVs (i.e., X relative to Y) is only dependent on the sample injection speed, a change of the electric field strength is effective to move the two critical boundary values with the same magnitude of ΔE_{BC}μₑₚ for both the exemplary symmetrical Y-shaped device 100 and the multiple-branched device 300.

The combined utilization of these two approaches can provide a convenient and powerful approach to regulate the absolute and relative positions of the two CBCs. By way of example, the position of the second CBC (Y), at which the steady-state migration velocity of the analyte reverses in the collection channel (BC), can be manipulated by adjusting the electric potential at the point (B), for example, and the position of the first CBC (X) can then be set by controlling the difference between the two CBCs, by way of changing sample injection speed.

### Continuous Chemical Purification in Exemplary Devices and the Sample Processing Speed

Because the CBVs are dependent on the electrophoretic mobility of the analyte, the present teachings provide for the purification and/or separation of one or more species of analytes in the sample fluid based on their distinctive migration pathways at certain electric field and hydrodynamic pressure conditions. As such, analyte species can be preferentially directed into specific collection locations. For example, in order to achieve this continuous chemical purification, the applied electric potential and counter pressure can make the slowest migrating components of the sample fluid follow the pathway of A-C-B to collection vial B, while all of the faster migrating components can exhibit a migration pathway of A-C-D by being preferentially driven into the main separation channel CD at the outlet junction (C) of the sample channel (AC). In order to obtain such a separation between the slow and fast moving sample components in the exemplary symmetrical Y-shaped EFD device 100, the magnitude of the net fluid velocity in collection channel (BC) should be within the range of:

E_{BC}μ_{ep,slow}+vᵢₙⱼ<−v_{f,BC}<E_{BC}μ_{ep,fast} (7)

Consequently, as long as the sample injection speed is kept in the range of

vᵢₙⱼ<E_{BC}(μ_{ep,fast}−μ_{ep,slow}) (8)

the magnitude of the net fluid velocity in the collection channel (BC) can be selected to be within the range indicated in Eq. (7) in order to achieve the continuous chemical purifications. Because of the existence of the maximum injection speed, the minimum sample mixture processing time can be calculated:

$$t = \frac{{V}_{t o t}}{{v}_{i n j} {S}_{AC}} > \frac{{V}_{t o t}}{{E}_{B C} ( {μ}_{ep , fast} - {μ}_{ep , slow} ) {S}_{AC}} \qquad ( 9 )$$

in which t is the time required to process the sample mixture with a volume of Vₜₒₜ.

On the other hand, for the exemplary multiple-branched device 300 in accordance with various aspects of the present teachings, the magnitude of the fluid velocity in the collection channel (BC) during continuous chemical purification occur is as follows:

$${E}_{B C} {μ}_{ep , slow} + \frac{1}{α} {v}_{i n j} = - {v}_{f , BC} < {E}_{B C} {μ}_{e p , f a s t} \qquad ( 10 )$$

As such, the requirement of the sample injection speed is:

vᵢₙⱼ<αE_{BC}(μ_{ep,fast}−μ_{ep,slow}) (11)

and the minimum sample processing time is

$$t = \frac{{V}_{t o t}}{{v}_{i n j} {S}_{A C}} > \frac{{V}_{t o t}}{α {v}_{i n j} ( {μ}_{ep , fast} - {μ}_{ep , slow} ) {S}_{AC}} \qquad ( 12 )$$

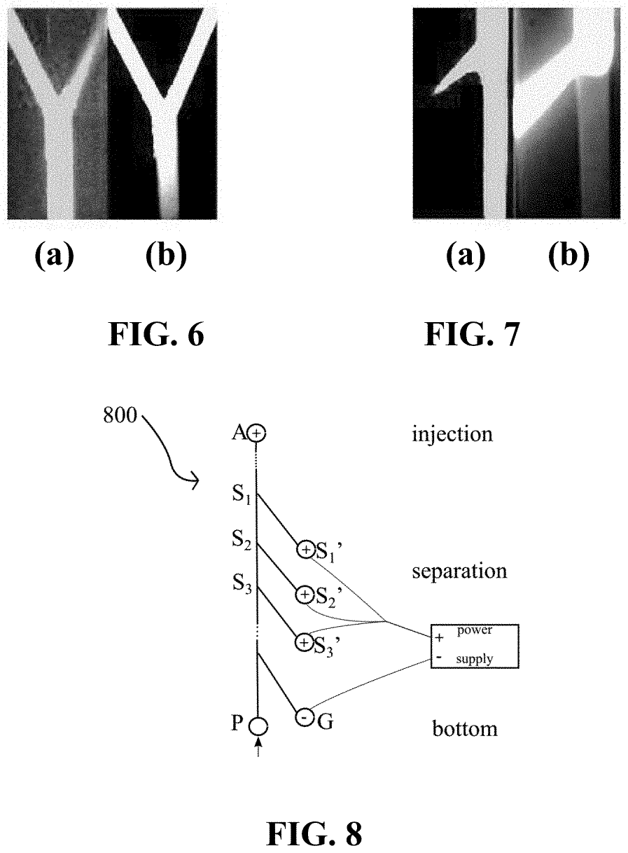

With reference now to FIG. 6, a continuous chemical purification process of two different dyes in the exemplary Y-shaped EFD device 100 is demonstrated. In FIG. 6, a mixture of two fluorescent dyes Rhodamine 110 (R110) and ethidium bromide (EB) were pumped through the sample channel (AC) of a prototype of the exemplary device 100 of FIG. 1 at a constant injection velocity, the R110 exhibiting a smaller μₑₚ relative to EB. A Nikon Eclipse 80i microscope was used in this study, and the fluorescence signals were recorded by an Andor EM CCD camera (South Windsor, Conn.). The optical band-pass filters used were from Thorlabs (Newton, N.J.), and their full width at half-maximum (fwhm) were 10 nm. When it was necessary to monitor the migration behaviors of two analytes simultaneously, the microscope was operated at two wavelengths using a MAG Biosystems dual-view filter (Optical in Sights, Tucson, Ariz.) with a 565 nm dichroic filter. A 530 nm filter was used for R110, and a 600 nm filter was used for EB. As shown, one dye preferentially enters the main separation channel (CD) of the device 100 (as shown in FIG. 6(a)) while the other dye preferentially enters the collection channel (BC) (as shown in FIG. 6(b)) under given conditions.

Likewise, with reference to FIG. 7, a continuous chemical purification process of two different dyes in the exemplary multiple-branched EFD device 300 is demonstrated. As shown in FIG. 7, one dye preferentially enters the main separation channel (CD) of the device 300 (FIG. 7(a)) while the other dye preferentially enters the collection channel (BC) (as shown in FIG. 7(b)) under given conditions. Though it appears in FIGS. 6 and 7 that some analyte may initially enter the unintended channels, the steady state flow defines the net migration behavior away from the immediate vicinity of the channel intersections such that the molecules are forced to go back to the proper theoretical channel if the channel is long enough.

Comparison with Electrokinetic Injection in Continuous Chemical Purification

As discussed above, systems and methods in accordance with various aspects of the present teachings can provide a more convenient approach for controlling the position of critical boundary conditions relative to known devices. Moreover, as demonstrated below for example with reference to the exemplary Y-shaped EFD device, sample processing speed and resistance to fluctuating electroosmotic flow (EOF) can also be increased in systems in accordance with the present teachings to provide improved operability in the continuous chemical purification process.

Because of the continuous nature of the chemical purification provided by the present teachings and known 2D-EFD devices, the amount of an analyte injected into the separation channel during a certain time period should equal the amount of an analyte processed and collected during that time period. It will thus be assumed that the sample processing speed can be described by the injection speed. In accordance with the present teachings, the injection speed for every analyte should be substantially the same (vᵢₙⱼ), which as described above in Eq. (8) should be selected to achieve the sample continuous purification as follows: vᵢₙⱼ<E_{BC}(μ_{ep,fast}−μ_{ep,slow}). In electrokinetic injection however, the speed of delivering components into the EFD device is analyte dependent, as follows:

vᵢₙⱼ=E_{AC}(μₑₒ+μₑₚ)+v_{p,AC} (13)

For example, if the counter-pressure during electrokinetic injection is relatively high, the analyte remains at the injection point A, and the injection speed is negative (or zero). However, when the counter pressure is reduced and the analyte follows the migration path of A-C-B, the magnitude of the pressure-induced velocity in the injection channel AC is in the range of 1/2(E_{AC}+E_{BC})(μₑₒ+μₑₚ)<|v_{p,AC}|=−v_{f,AC}<E_{AC}(μₑₒ+μₑₚ), and the range of the injection speed of the analyte in this migration situation is:

0<vᵢₙⱼ<1/2(E_{AC}−E_{BC})(μₑₒ+μₑₚ) (14)

Similarly, if the analyte has the migration pathway of both A-C-B and A-C-D, the injection speed range is:

1/2(E_{AC}−E_{BC})(μₑₒ+μₑₚ)<vᵢₙⱼ<(E_{AC}−E_{BC})(μₑₒ+μₑₚ) (15)

If the analyte migrates along the way of A-C-D, the injection speed range is

vᵢₙⱼ>(E_{AC}−E_{BC})(μₑₒ+μₑₚ) (16)

Thus, for the continuous separation of analytes when utilizing electrokinetic injections, the pressure-induced velocity in the sample channel (AC) should be controlled in the range of making the faster migration components have the migration path of A-C-D, while the slower components have the migration path of A-C-B, which is

1/2(E_{AC}+E_{BC})(μₑₒ+μ_{ep,slow})<|v_{p,AC}|=−v_{f,AC}<E_{BC}(μₑₒ+μ_{ep,fast}) (17)

Accordingly, in electrokinetic injection, the sample processing speed for the mixture is limited by the injection speed of the slower component, which is

E_{AC}(μₑₒ+μ_{ep,slow})−E_{BC}(μₑₒ+μ_{ep,fast})<v_{inj,slow}<1/2(E_{AC}−E_{BC})(μₑₒ+μ_{ep,slow}) (18)

Assuming that the electric fields in the collecting channels have the same strength in both the exemplary devices 100, 300 described herein in accordance with the present teachings and those device that instead utilize electrokinetic injection, the difference in the maximum injection speed is:

$${E}_{A C} ( {μ}_{e p , f a s t} - {μ}_{ep , slow} ) - \frac{1}{2} ( {E}_{AC} - {E}_{B C} ) ( {μ}_{e o} + {μ}_{ep , slow} ) = {E}_{B C} ( {μ}_{e p , f a s t} ) - \frac{1}{2} {E}_{B C} {μ}_{ep , slo w} + \frac{1}{2} {E}_{B C} {μ}_{e o} - \frac{1}{2} {E}_{A C} {μ}_{e o} - \frac{1}{2} {E}_{A C} {μ}_{ep , slo w} = {E}_{B C} ( {μ}_{e o} + {μ}_{e p , f a s t} ) - \frac{1}{2} ( {E}_{A C} + {E}_{B C} ) ( {μ}_{e o} + {μ}_{ep , slow} ) \qquad ( 19 )$$

Because the value of Eq. (19) is positive during the continuous chemical purification process, present teachings that utilize hydrodynamic forces to deliver the sample fluid to the outlet junction can provide faster sample processing speeds (assuming electric field strength in the collection channel (BC) is the same in each of the injection modes). If the electrical voltage at point (B) (not E_{BC}) is kept the same in both modes, an additional electric potential applied at the sample inlet (A) in the electrokinetic injection approach could further decrease the value of E_{BC}, resulting in an even slower sample processing. As such, methods and systems in accordance with the present teachings can provide a faster sample processing speed compared with known electrokinetic sample injection.

Because surface properties of the microfluidic channel wall can change over time during the continuous chemical purification process, the application of a positive electrical potential at the sample inlet as in electrokinetic injections could induce electrolysis of the buffer solution, thereby altering the buffer pH and making the EOF unstable as well, which could additionally effect the sample processing speed and analyte migration velocity.

In methods and systems in accordance with the present teachings, the electric field strength within the injection channel is substantially zero. For example, the current flowing through the injection channel AC could be monitored and adjusted to be zero. The sample injection speed is controlled by manipulating, for example, a pump (e.g., a syringe pump) utilized to deliver the sample fluid through the sample channel (AC) from the inlet end (A) to the outlet junction (C). The range of the injection speed during the continuous chemical purification is 0<vᵢₙⱼ<E_{BC}(μ_{ep,fast}−μ_{ep,slow}), which is EOF independent. Because the counter-flow can also be controlled in the way of volumetric flow rate by the counter-flow pump (e.g., a second syringe pump), it can be assumed that the net fluid velocity in the main separation channel (CD) also remains the same under different EOF conditions. Accordingly, in channel CD, the net velocity of the component is as follows:

v_{CD}=E_{CD}μₑₚ+v_{f,CD} (20)

which is not affected by the EOF value. Because the migration velocity in the sample channel (AC) can be fixed at vᵢₙⱼ, due to the effective volumetric flow rate conservation principle, the migration velocity in collection channel (BC) can be unaffected by an unstable EOF.

In electrokinetic injection, however, sample injection speed, described by Eq. (13), can be rearranged as follows because

$${v}_{p , AC} = \frac{1}{2 α} {v}_{p , C D} and {v}_{p , C D} = {v}_{f , C D} - {E}_{C D} {μ}_{e o} \text{:}$$

$$\begin{matrix}{v}_{i n j} = {E}_{A C} ( {μ}_{e o} + {μ}_{e p} ) - \frac{1}{2 α} ( {v}_{f , C D} - {E}_{C D} {μ}_{e o} ) \\ = {E}_{A C} {μ}_{e p} - \frac{1}{2 α} {v}_{f , C D} + ( {E}_{A C} + \frac{1}{2 α} {E}_{C D} ) {μ}_{e o}\end{matrix} \qquad ( 21 )$$

Due to the electric field strength relationship (αE_{AC}+αE_{BC}+E_{CD}=0), and that E_{AC}>E_{BC} during the purification process in a symmetrical Y-shaped device,

$${E}_{A C} + \frac{1}{2 α} {E}_{C D}$$

doesn't equal to zero in electrokinetic injection, and thus may be susceptible to an unstable EOF and fluctuation of the sample injection speed.

Moreover, as described in Eq. (17), in the electrokinetic injection mode, the magnitude of the pressure-induced velocity in collection channels should be kept in the range of 1/2(E_{AC}+E_{BC})(μₑₒ+μ_{ep,slow})<|v_{p,AC}|=−v_{f,AC}<E_{BC}(μₑₒ+μ_{ep,fast}). During the continuous chemical purification process, the injection speed for the faster moving component (v_{inj,fast}=E_{AC}(μₑₒ+μ_{ep,fast})+v_{p,AC}) is in the range of

(E_{AC}−E_{BC})(μₑₒ+μ_{ep,fast})<v_{inj,fast}<E_{AC}(μₑₒ+μ_{ep,fast})−1/2(E_{AC}+E_{BC})(μₑₒ+μ_{ep,slow}) (22)

and for the slower migration component, the injection speed range (v_{inj,slow}=E_{AC}(μₑₒ+μ_{ep,slow})+v_{p,AC}) is:

E_{AC}(μₑₒ+μ_{ep,slow})−E_{BC}(μₑₒ+μ_{ep,slow})<v_{inj,slow}<1/2(E_{AC}−E_{BC})(μₑₒ+μ_{ep,slow}) (23)

Therefore, the possible range for the sample injection speed is also EOF dependent for both faster and slower migration analytes.

Accordingly, the sample injection speed, as well as the range of possible injection speed flow rates, are all affected by the fluctuating EOF value in the electrokinetic injection mode. That is, although the analyte net migration velocity in the separation channel (CD) may remain unchanged during electrokinetic injection, the fluctuating injection speed in the sample channel (AC) can induce a changing velocity in the collection channel (BC) based on the principle of conservation of effective volumetric flow rate.

In addition to the present teachings enabling faster processing and reducing the effects of EOF instability, methods and systems in accordance with the present avoid buffer depletion that commonly occurs in known 2D-EFD devices during prolonged sample injection due to electrolysis of the sample buffer at the sample inlet from the electrode at the sample inlet. That is, whereas an electrode is directly placed into the sample vial in electrokinetic injection, methods and systems in accordance with various aspects of the present teachings do not use an electrode at the sample inlet and instead utilize pressure to drive the sample fluid (and the analyted contained therein) to the outlet junction.

Therefore, the systems and methods in accordance with the present teachings can be superior to electrokinetic injection in the continuous chemical purification process, which can provide faster sample processing, be more resistant to the fluctuating EOF, and avoid buffer depletion that is common in known 2D-EFD device.

It will be appreciated that various of the above-disclosed and other features and functions, or alternatives thereof, may be desirably combined into many other different systems or applications. It will also be appreciated that various presently unforeseen or unanticipated alternatives, modifications, variations or improvements therein may be subsequently made by those skilled in the art which alternatives, variations and improvements are also intended to be encompassed by the following claims.

1. A method of continuously separating fluids based on electrophoretic mobility comprising:
pumping a sample fluid from an inlet end of one of a sample channel and sample channel network to an outlet junction;
pumping a counter-flow fluid from an inlet end of one of a separation channel and separation channel network to the outlet junction;
generating an electric field in the one of the separation channel and separation channel network, during said pumping of said sample fluid and said counter-flow fluid such that one or more analytes in the sample fluid at the outlet junction are driven into said one of the separation channel and separation channel network and at least one of a collection channel and collection channel network in fluid communication with said one of the separation channel and separation channel network and said one of the sample channel and sample channel network at the outlet junction.

2. The method of claim 1, further comprising adjusting at least one of a volumetric flow rate of the fluid sample, a volumetric flow rate of the counter-flow fluid, and the electric field such that at least a first species of analyte is driven into said one of the collection channel and collection channel network.

3. The method of claim 1, wherein one of the sample channel and sample channel network comprises an electric field-free pathway.

4. The method of claim 1, further comprising pumping the sample fluid at a constant volumetric flow rate while adjusting a volumetric flow rate of the counter-flow fluid so as to effect an interaction between a hydrodynamic force and electric field experienced by the one or more analytes at the outlet junction.

5. The method of claim 1, wherein at least one of the collection channel and collection channel network extends from the outlet junction to a respective fluid reservoir, each reservoir containing an electrode in contact with fluid in the respective fluid reservoir.

6. The method of claim 5, wherein at least one of an average cross-sectional area and a channel length of said one of the collection channel and collection channel network differ from one another, the method further comprising:
maintaining the potential applied to the collection electrodes equal.

7. The method of claim 6 wherein the analytes within the sample fluid are pumped from the sample inlet to the first intersection point either electrokinetically by the sample electrode or hydrodynamically by the fluid pump.

8. The method of claim 5, wherein at least one of an average cross-sectional area and a channel length of said one of the collection channel and collection channel network are equal to one another, the method further comprising:
applying an electric potential of different magnitudes to the first and second electrodes.
